(19) United States
(12) Patent Application Publication
(10) Pub. No.: US 2017/0323713 A1
(43) Pub. Date: Nov. 9, 2017

(54) Electrical Machines With SMC Cores

(71) Applicant: GKN Sinter Metals Engineering GmbH, Radevormwald (DE)

(72) Inventors: Frank Heinrich Moeller, Radevormwald (DE); John Tasker, West Midlands (GB)

(21) Appl. No.: 15/522,971

(22) PCT Filed: Oct. 28, 2015
(86) PCT No.: PCT/EP2015/075036

§ 371 Date: Apr. 28, 2017

(30) Foreign Application Priority Data
Oct. 28, 2014 (GB) 1419179.5

(51) Int. Cl. H01F 1/20; H02K 15/03; H02K 7/14; H02K 1/02; H02K 1/27; H02K 1/14; H02K 21/24; H02K 15/02

(52) U.S. Cl. CPC H01F 1/20; H02K 21/24; H02K 15/03; H02K 15/02; H02K 1/02; H02K 1/2793; H02K 1/146; H02K 7/14

(57) ABSTRACT

An electrical machine is disclosed. The electrical machine has a first part and a second part, the first part moveable relative to the second part. One of the first part and the second part has a plurality of cores for current-carrying windings. Each core is of soft magnetic composite material (SMC) and is shaped to be no wider at its ends than along its length.

### FIELD

The present invention relates to electrical machines with cores formed of soft magnetic composite material (SMC) and a method to manufacture cores made from powder SMC. In embodiments, it relates to electrical machines with yokes and flux concentrators formed of SMC.

### BACKGROUND

Electrical machines for automotive propulsion, such as for use in driving an electric bicycle, in locomotives, or in passenger cars, require high performance and efficiency over a large speed range, as well as low weight. Meeting these requirements in an electrical machine is, however, typically costly. The high cost of mass-producing existing electrical machines that meet these requirements is a barrier to their more extensive use.

It is thus generally desirable that an electrical machine that is efficient over a large speed range, yet is inexpensive to manufacture, be designed.

Although the material known as SMC (Soft Magnetic Composite) has been known for many years, it is not widely used. SMC is formed of iron powder particles that are electrically insulated from each other. Iron losses in SMC parts in an alternating electric field are generally low. In this respect, therefore, it would appear desirable to use SMC in electrical machines in place of the more commonly-used steel lamination. SMC can be, however, difficult to work with. To form a component from SMC, the particles are compacted and cured. It is difficult to compact and cure SMC parts that are complicated in shape or thin in section. Furthermore, the parts produced are very brittle and generally require support by other materials, such as aluminium, steel, cast iron or composite material.

### SUMMARY

The present inventors have found an arrangement for an electrical machine which makes use of SMC in a simple and thus easy to produce form. Electrical machines made in this arrangement have high performance and efficiency over a large speed range. They can be mass-produced at lower cost than electrical machines using steel laminations. They are also easier to manufacture than such machines.

According to a first aspect of the invention, there is provided an electrical machine having a first part and a second part, the first part moveable relative to the second part, one of the first part and the second part having a plurality of cores for current-carrying windings, wherein each core is of soft magnetic composite material (SMC) and is shaped to be no wider at its ends than along its length.

This means that besides any material deviation based on manufacturing influences during compressing and expanding the powder soft magnetic composite material, no wider end is construed. Any deviation based by material behaviour is therefore less than a millimeter difference or, in relation to the axis of the core, less than 1° deviation to a parallel axis.

One or more features of one or more embodiments of the general description or of the specific figures might be used with one or more features of another embodiment or embodiments to show different opportunities of the invention. Therefore, any feature of an embodiment is not restricted only to this specific embodiment but is to be understood in a broader sense, only as an example.

[No Pole Shoes]

The cores, in being shaped to be no wider at their ends than along their lengths, allow for easier placement onto the cores of coils for carrying current than if they were wider at their ends than along their lengths. This shape allows for a pre-wound coil to be slid on to each core, and to fit snugly around the core. This would not be possible if the cores had pole shoes, since a pre-wound coil would either not fit over the pole shoe of a core, or, if it did fit over the pole shoe, would be loose.

Furthermore, cores formed from SMC shaped to be no wider at their ends than along their lengths (that is, without pole shoes) are easier to make and much less fragile than SMC cores with pole shoes, due to their simpler shape.

Pole shoes are typically used on cores in permanent magnet electrical machines to reduce the flux density adjacent the magnets of these machines. Where SMC is used for the electrical machine cores, however, the present inventors have discovered that pole shoes are, unexpectedly, unnecessary. Since SMC has lower magnetic flux permeability than steel laminations and saturates at approximately 1.5 Tesla, the maximum flux passed by the SMC cores is very similar to the maximum allowed flux levels in Neodymium-based permanent magnets in electrical machines. Neodymium-based magnets are the most commonly used in high-performance electrical machines. At up to 1.5 Tesla, there is little risk of demagnetising Neodymium-based magnets.

In embodiments in which each magnet comprises Ferrite, or other materials apart from Neodymium, the magnets can be demagnetised at lower flux densities. The feature of SMC that it has low iron losses even when used at high pole switching frequencies means that the lower allowable flux density can be compensated for by running an electrical machine with such magnets at higher pole switching frequencies and speed. Thus, lower-cost magnets can be used with the present electrical machine, without the performance penalties typically associated with these.

[What is a Core?]

Each core may be an element arranged to be magnetised when a current is passed through current-carrying windings about the core.

[Current-Carrying Windings]

The electrical machine may comprise a plurality of current-carrying windings. The current-carrying windings may be coils. Each coil may be substantially the same as each other coil. Each coil may have an inner diameter substantially equal to an outer diameter of each core.

[Core Shape]

Each core may be arranged to support the current-carrying windings around a first surface. The first surface may be substantially smooth. The first surface may have no sharp corners. The first surface may have no corners. The first surface may have rounded corners. Each core may be substantially circular in cross-section. Each core may be substantially cylindrical in shape.

Each core may be shaped such that when a plurality of cores is arranged side-by-side, a substantially continuous annulus is formed by the plurality of cores. Each core may be substantially the shape of the sector of an annulus in cross-section. Each core may be substantially an annular sector in cross-section. Each core may have a cross-sectional shape having an outline described by a two circles joined by two non-intersecting tangents to the circles. Each core may be substantially oval in cross-section. Each core may be substantially triangular in cross-section. Each core may be substantially trapezoidal in cross-section.

In embodiments in which the cores are substantially circular in cross-section, they can carry a greater length of current-carrying winding for a given volume of core when compared to cores of a different cross-section. As such, the winding has lower electrical resistance, resulting in good efficiency.

In embodiments in which the cores are not circular in cross-section, the cores have a greater cross-sectional area for a given motor volume. This gives a greater torque potential, although the overall efficiency at a given load will generally be lower than with cores that are circular in cross-section.

Cores with no sharp corners in the surface on which they support current-carrying windings are easier to manufacture than cores with sharp corners, since, as mentioned above, SMC can be brittle.

In being shaped to be no wider at its ends than along its length, each core may have no pole shoe. Each core may be of the substantially the same width along its length. Each core may be of substantially constant cross-section.

Furthermore, without pole shoes, the cores have a greater length which can be used for carrying a coil, without requiring the overall length of the core to be increased. This helps to achieve better efficiency.

[Long Cores]

Each core may be shaped to have a length greater than a diameter of the core. Each core may be shaped to have a length as many times greater than a diameter of the core as can be achieved with substantially uniform density of the core. Each core may be shaped to have a length of at least 1.5 times its greatest diameter. Each core may be shaped to have a length of at least 2 times its greatest diameter. Each core may be shaped to have a length of at least 3 times its greatest diameter. Each core may be shaped to have a length of at least 3.5 times its greatest diameter. Each core may be shaped to have a length of at least 4 times its greatest diameter. Each core may be shaped to have a length of at least 5 times its greatest diameter. Each core may be shaped to have a length of at least 6 times its greatest diameter. Each core may be shaped to have a length of at least 7 times its greatest diameter. Each core may be shaped to have a length of at least 8 times its greatest diameter. Each core may be shaped to have a length of at least 9 times its greatest diameter. Each core may be shaped to have a length of at least 10 times its greatest diameter.

The longer the core that is used, the greater the number of turns of current-carrying winding which can be accommodated on the core. Since torque is proportional to current multiplied by the number of turns of winding around the core, longer cores in an electrical machine give increased torque.

Longer cores can therefore increase the efficiency and the power-to-weight ratio of the electrical machine. Long cores for machines with many magnetic poles also reduce the amount of coil conductor (reduced coil diameter) and magnetic material (reduced magnet diameter) per effective propulsion torque (force) levels.

The optimum ratio of the diameter of each core to its length depends on the application and the duty required of an electrical machine comprising the cores. For slow-running machines (for example electrical machines directly coupled to wind turbines or bicycle hubs), the optimum core length could be at least 10 times the diameter of the core.

[SMC]

In being formed of soft magnetic composite material, each core may be formed of a plurality of coated metal particles. The metal may be iron. The metal may be ferro-magnetic. The metal particles may be heat-treated. The metal particles are compacted and then heat-treated. The temperature might be in the range between 450° C. to 750° C., especially below sintering temperature. This helps to achieve a homogenous density distribution of the particles, giving improved magnetic properties. The metal particles may be cured.

Each particle may be substantially electrically insulated from each other particle. Each particle may be coated in a substantially electrically insulating material.

In being formed of soft magnetic composite material, each core may be formed of a plurality of ferro-magnetic particles, and each particle may be substantially electrically insulated from each other particle.

Parts produced from SMC have lower electrical conductivity than most laminated steel structures presently used in electrical machines. Because of the electrical insulation between the particles of an SMC part, such a part has lower magnetic flux permeability than a comparable laminated steel structure. As such, an SMC part can reach saturation at approximately 1.5 Tesla (a lower rating than a steel laminated structure, which saturates at around 2.0 Tesla).

Preferably, flux in the electrical machine is kept below this level. Preferably, SMC parts have lower iron losses than comparable laminated steel parts. This is especially true at the high frequencies typical in the high performance permanent magnet machines which are commonly used for automotive propulsion. The result of using SMC is generally better mean efficiency at high speed and high pole switching frequencies. This is especially true when the average power required to be produced is low, which is the case with most automotive vehicles since the power requirements in towns and cities is probably only about 10 percent of maximum power installed.

Forming parts from SMC rather than from laminated steel or steel alloy is less expensive and wasteful. For example, to form a disc-shaped backing, or yoke, for magnets in the electrical machine (as described below), from laminated steel, a disc must be cut from a piece of laminated steel and then a hole cut in that disc. The material cut from the centre of the disc is therefore wasted. By contrast, such a yoke can be formed from SMC (rather than cut from it), thereby reducing the amount of material required to make the yoke.

[Magnets—Round]

One of the first part and the second part may have a plurality of magnets. The part not having the plurality of cores for current-carrying windings may have the plurality of magnets. Each magnet may be substantially round in cross section. Each magnet may be of substantially the same cross section as each other magnet. Each magnet may be of substantially the same diameter as each other magnet.

The combination of substantially round cores and substantially round magnets has been found to give the best running efficiency for the electrical machine. This is because the change in polarity between round magnets is gradual; i.e. the polarity does not change at a straight edge.

[Magnets—Material]

Each magnet may comprise Neodymium. Each magnet may comprise Ferrite. Each magnet may comprise conceivably any other magnetic material.

The magnets may be a plurality of current-carrying windings. The second plurality of current-carrying windings may carry direct current. The second plurality of current-carrying windings may be a plurality of coils. The second plurality of current-carrying windings may be a plurality of solenoids.

In embodiments in which the first part or the second part has a second plurality of current-carrying windings, the number of current-carrying windings may be the same as any of the numbers of magnets above, with similar advantages arising.

[Magnets—Sector-Shape]

Each magnet may be shaped such that when a plurality of magnets is arranged side-by-side, a substantially continuous annulus is formed by the plurality of magnets. Each magnet may be substantially the shape of the sector of an annulus in cross-section. Each magnet may be substantially an annular sector in cross-section. Each magnet may be substantially an annular sector in cross-section. Each magnet may be arranged to substantially abut radially two other magnets. In this way, gaps between the magnets are reduced.

The combination of magnets of this shape and round cores can greatly reduce cogging. This arrangement is particularly suitable for electric bicycle drives, and for power-steering in other vehicles. In an electric bicycle, full torque is required from the beginning of acceleration and lumpiness due to cogging is perceived as a greater problem than in, for example, an electrical machine used for propulsion of a heavy vehicle.

Each magnet may have a cross-sectional shape having an outline described by a two circles joined by two non-intersecting tangents to the circles. Each magnet may be substantially oval in cross-section. Each magnet may be substantially triangular in cross-section. Each magnet may be substantially trapezoidal in cross-section.

[Shape of Cores and Magnets]

Each magnet may have substantially the same cross-sectional shape as each core. Each magnet may have substantially the same shape in cross section as each core. The greatest diameter of each magnet may be greater than the greatest diameter of each core. The cross-sectional area of each magnet may be greater than the cross-sectional area of each core. In this way, any fringing flux increases the total flux flow. Thus, the maximum torque performance of this arrangement is greater than that of arrangements in which the greatest diameter of each magnet is the same as or less than the greatest diameter of each core.

[Number of Cores and Magnets]

The electrical machine may be arranged to operate using a three-phase electrical supply. There may be an even number of cores. The number of magnets may be the number of cores plus 1. The number of magnets may be the number of cores minus 1. The number of magnets may be the number of cores plus 2. The number of magnets may be the number of cores minus 2. The number of coils and magnets in the electrical machine is dependent on the application and performance (torque, speed) required.

By having a different number of cores to the number of magnets, cogging is greatly reduced, because in this way, most magnets and cores are never aligned to produce a detent force. Higher numbers of magnets and cores also generally result in reduced cogging, because although the cogging frequency is increased, its amplitude is greatly reduced. In addition, higher numbers of magnets and cores reduce the weight of the machine because of the higher pole switching frequency required for a given speed.

[Rotating Machine]

The electrical machine may be a rotating electrical machine. The part having the cores may be the first part. The first part may be a rotor. The part having the cores may be the second part. The second part may be a stator. The electrical machine may be an axial flux electrical machine.

The electrical machine might comprise a back plate of a stator comprising compressed soft magnetic composite powder material (SMC). The back plate is in contact with each core made from compressed soft magnetic composite powder material (SMC). Preferably, the back plate and the cores are made together as a single component out of compressed soft magnetic composite powder material (SMC).

The electrical machine might also comprise a rotor adjacent to a stator of the electrical machine. The rotor comprises a plurality of magnets wherein at least a part of the rotor in contact with the magnets is made from compressed soft magnetic composite powder material (SMC). The magnets might be pressed into the back plate which has a sufficient thickness for that.

Preferably, the rotational electrical machine comprises at least a single stator adjacent to one single rotor, one single rotor between two stators or one single stator between two rotors. The rotor and/or the stator might preferably be manufactured as described above or in the following.

[Twin Yokes]

The plurality of magnets may comprise a first set of magnets and a second set of magnets. The number of magnets in the first set may be equal to the number of magnets in the second set. The plurality of cores may be arranged axially between the first set of magnets and the second set of magnets. The plurality of current-carrying windings may be arranged axially between the first set of magnets and the second set of magnets. Since in this arrangement there are two sets of magnets, each with an equal number of magnets, one set axially on each side of the current-carrying windings, axial magnetic forces in the electrical machine are balanced.

[Multiple Arrays of Poles and Magnets]

In embodiments in which the electrical machine is a rotating electrical machine, the plurality of cores for current-carrying windings may be a first plurality of cores, and the part having the first plurality of cores may further have a second plurality of cores. There may be a plurality of pluralities of cores. Each of the plurality of cores may be arranged concentrically with each other plurality. Each plurality of cores may be arranged co-axially with each other plurality of cores.

In embodiments in which the electrical machine is a rotating electrical machine and the part not having the plurality of cores for current-carrying windings has a plurality of magnets, the plurality of magnets may be a first plurality of magnets and the part having the first plurality of magnets may further have a second plurality of magnets. There may be a plurality of pluralities of magnets. Each of the plurality of magnets may be arranged concentrically with each other plurality. Each plurality of magnets may be arranged co-axially with each other plurality of magnets.

The number of pluralities of cores may be equal to the number of plurality of magnets. Each plurality of cores may be arranged at a radial distance from the axis substantially equal to the radial distance from the axis at which a corresponding plurality of magnets is arranged.

The use of more than one plurality of cores and of magnets provides more active parts within a limited space. In providing more active parts, it can considerably enhance the performance of the machine.

[Powered Wheel]

According to a second aspect of the invention, there is provided an axle apparatus for a vehicle, the axle apparatus comprising the electrical machine of the first aspect. The first part may be arranged to be mounted to an axle for a vehicle. The first part may be mounted to an axle for a vehicle. The first part may be a wheel for a vehicle. The first part may be arranged to be mounted to a wheel for a vehicle. The first part may be mounted to a wheel for a vehicle. The first part may be a brake disc for a vehicle. The first part may be arranged to be mounted to a brake disc for a vehicle. The first part may be mounted to a brake disc for a vehicle. The brake disc may be arranged to be mounted to an axle for a vehicle. The first part may be arranged to be stationary relative to the axle. The first part may be arranged to rotate relative to the vehicle. The second part may be arranged to be stationary relative to the vehicle.

Mounting a part of the electrical machine to an axle or a wheel (or using the axle or wheel as a part of the electrical machine) eliminates the need for a gear transmission between an electrical machine and the axle to drive the axle. The cost and weight of such an arrangement can therefore be lower than an arrangement with a gear transmission. In addition, the efficiency and speed capability can be superior, because there are no gear trains having to run at high speed, and no transmission losses.

[Engine Flywheel]

According to a third aspect of the invention, there is provided a flywheel apparatus for an internal combustion engine, the flywheel apparatus comprising the electrical machine of the first aspect. The first part may be a flywheel for connection to a crankshaft of an internal combustion engine. The first part may be arranged to be mounted to a flywheel for connection to a crankshaft of an internal combustion engine. The first part may be arranged to be stationary relative to a crankshaft of an internal combustion engine. The first part may be arranged to rotate relative to the vehicle. The second part may be arranged to be stationary relative to the vehicle.

[Further Applications]

The electric machine might also be used in different further applications: as a part of a medical device, preferably a blood or heart pump, a compressor, a van, preferably an air conditioning compressor, a fluid pump, a part of a wind turbine, preferably of a vertical axis wind turbine, especially a Darrieus wind turbine, an automotive part, a bicycle part, a motorbike part, a train part, a gear par and/or a driveline part. The electrical machine might be used in different sorts of vehicles, especially those as mentioned, but also in planes, submarines, drones, RC-models, electric bikes or cars, hybrid vehicles. The electric machine might be used as a direct drive without or with a gear, and/or as linear motor. Especially use of the electric machine is in all areas where only limited space is available.

[SMC Yoke]

The part having the plurality of magnets may comprise a substrate on which the magnets are mounted. The substrate may be formed of SMC. When the plurality of magnets comprises a first set of magnets and a second set of magnets, there may be two substrates. Each substrate may support at least one set of magnets. Each substrate may be a yoke. Each substrate may be annular in shape. Each substrate may be made up of a plurality of substrate segments. Each substrate segment may be substantially arcuate in shape. Each substrate segment may be substantially the sector of an annulus in shape. Each substrate segment may be an annular sector in shape. Each substrate segment may be arranged to substantially abut radially two other substrate segments.

Mounting the magnets on a substrate formed of SMC reduces iron losses compared to mounting the magnets on a steel part, especially at high operating speeds. SMC is brittle and so forming and curing large parts in SMC is difficult. Assembling the SMC lining ring from segments of SMC means that smaller parts are required to be made than if it were formed in one piece and manufacture of the SMC lining ring is therefore made easier.

In embodiments in which the substrate is made up of a plurality of substrate segments, and each substrate segment is arranged to substantially abut radially two other substrate segments, a magnet may be mounted at each point where two substrate segments substantially abut. A magnet may be axially mounted radially across two adjacent substrate segments. A magnet may be axially mounted radially across two adjacent substrate segments such that a first volume of the magnet axially over a first substrate segment is substantially equal to a second volume of the magnet axially over a second substrate segment, the first substrate segment adjacent the second substrate segment. This arrangement is advantageous because there is a low level of circumferential flux in the substrate at the positions where substrate segments abut.

[Linear Machine]

The electrical machine may be a linear electrical machine.

[Flux Concentrators]

The electrical machine may further comprise an element of SMC coupled to each magnet, each element shaped to increase the density of magnetic flux through a core. Each element may be coupled to a face of each magnet that is axially proximate a core. Each element may be coupled to the active side of each magnet. Each element may be shaped to have a first face having an area substantially equal to the cross-sectional area of the magnet to which it is coupled, and a second face having an area substantially equal to the cross-sectional area of a core, and may be arranged such that the first face is axially proximate the magnet and the second face is axially proximate a core. When each magnet is round in cross-section, each element may be substantially a conical frustum in cross-section.

The elements of SMC (or “SMC elements”) channel magnetic flux in a similar manner to pole shoes in conventional electrical machines. Since the SMC elements are separate from the cores, they are simpler in shape than cores with pole shoes, and are thus easier to manufacture. In increasing the density of magnetic flux through the cores, the SMC elements allow lower-cost magnets to be used, without the performance penalties typically associated with these.

[Method of Manufacturing Cores]

As discussed above, longer cores are advantageous. They are, however, difficult to make using present methods of manufacturing parts from SMC. Using present methods, SMC powder is placed in a die with a cross-sectional shape corresponding to the cross-sectional shape of the part to be produced. A punch is then used to compress the SMC powder in the die, in a direction parallel to the axis of the part to be formed. For short parts, the punch is able to compress the powder relatively evenly. For parts having a length of approximately 1.5 times their width, or greater, the powder is not compressed evenly. Thus the density of the part from the centre of the die towards the lower part is less than the density of the part at the upper end. Such a part does not conduct magnetic flux as well as a part of more uniform density.

An alternative existing method is therefore to gradually build up the part, by placing SMC powder in a die, compressing the powder using a punch, withdrawing the punch, adding more SMC powder, and compressing this. This process must be repeated several times to produce long parts with satisfactorily uniform densities. Such long SMC cores from powder material can be used as the cores will not suffer from huge mechanic loads.

According to a fourth aspect of the invention, there is provided a method of manufacturing a core according to the first aspect, the method comprising the steps of:
(a) compressing SMC powder to form a first part of substantially uniform density;
(b) compressing SMC powder to form a second part of substantially uniform density; and
(c) compressing the first part and the second part together to form a core of substantially uniform density.

The method may comprise an additional step of compressing SMC powder to form a third part of substantially uniform density, and step (c) may comprise compressing the first, second and third parts together. The method may comprise compressing SMC powder to form conceivably any number of parts, and compressing these parts together to form a core of substantially uniform density. Step (a) and step (b) may each be performed in a first die of a first length. Step (c) may be performed in a die of a second length, longer than the first length. The compression in each step may be along the direction of the axis of the part or core.

In this way, longer cores can be formed with a substantially uniform density.

According to further alternative ideas of the invention which might be dependent or independent from any further idea or aspect of the invention, the core might be manufactured by additive manufacturing or be injection moulding.

It is preferred to manufacture a plurality of cores together with a back plate of the stator as a single piece. Alternatively, the cores and the back plate are manufactured independently from each other and then combined to form the stator of the electrical machine. Preferably, press fits are used to hold the cores in the back plate.

According to a further aspect of the invention the stator might be made totally from powder soft magnetic composite material. Preferably, the cores have an insulation at their surfaces in relation to the coils. The insulation might be a lacquer. The cores respectively the stator might be dived into a bath of lacquer to generate the electrical insulation coating. Any other form of generating an electric insulation might also be used. For example, the coils might be winded onto a plastic sleeve to be used on a core.

According to a fifth aspect of the invention, there is provided an electrical machine having a first part and a second part, the first part moveable relative to the second part, one of the first part and the second part having a plurality of cores for current-carrying windings, wherein each core is of soft magnetic composite material (SMC) and has no pole shoes.

According to a sixth aspect of the invention, there is provided an electrical machine having a first part and a second part, the first part moveable relative to the second part, one of the first part and the second part having a plurality of cores for current-carrying windings, wherein each core is of soft magnetic composite material (SMC) and is of substantially constant cross-section.

### BRIEF DESCRIPTION OF THE DRAWINGS

Specific embodiments of the invention are described below by way of example only and with reference to the accompanying drawings, in which:

FIG. 1a is an axial schematic view of a first embodiment of the electrical machine;

FIG. 1b is a cross-sectional schematic view of the electrical machine of the first embodiment;

FIG. 2 is an axial scrap schematic view of the electrical machine of the first embodiment;

FIG. 3 is a schematic depiction of the general arrangement of cores, coils and magnets and magnetic flux lines in the described embodiments;

FIG. 4a is an axial schematic view of a second embodiment of the electrical machine;

FIG. 4b is a cross-sectional schematic view of the electrical machine of the second embodiment;

FIG. 5 an axial scrap schematic view of the electrical machine of the second embodiment;

FIG. 6 is a side scrap schematic view of a third embodiment of the electrical machine;

FIG. 7 is a cross-sectional schematic view of a fourth embodiment of the electrical machine;

FIG. 8 is a cross-sectional schematic view of a fifth embodiment of the electrical machine;

FIG. 9 is a schematic depiction of the arrangement of magnets and SMC segments in a rotor yoke forming part of a sixth embodiment of the electrical machine;

FIG. 10 is a schematic depiction of the arrangement of segments in a rotor yoke forming part of a seventh embodiment of the electrical machine;

FIG. 11 is a schematic depiction of the cross-sectional shape of a core, a magnet and a coil around a core, all forming part of an eighth embodiment of the electrical machine;

FIG. 12 is a part cross-sectional schematic view of a ninth embodiment of the electrical machine of the electrical machine, with SMC elements, or “flux concentrators” mounted on the magnets;

FIGS. 13a, 13b and 13c show steps in a process of making a core for an electrical machine; and

FIGS. 14, 15 and 16 each shows a specific stator-rotor arrangement of the electrical machine.

One or more features of one or more embodiments above or below might be used with one or more features of another embodiment or embodiments to show different opportunities of the invention. Therefore, any feature of an embodiment is not restricted only to this specific embodiment but is to be understood in a broader sense only as an example.

### SPECIFIC DESCRIPTION OF CERTAIN EXAMPLE EMBODIMENTS

[Outer Stator Rotating Electrical Machine]

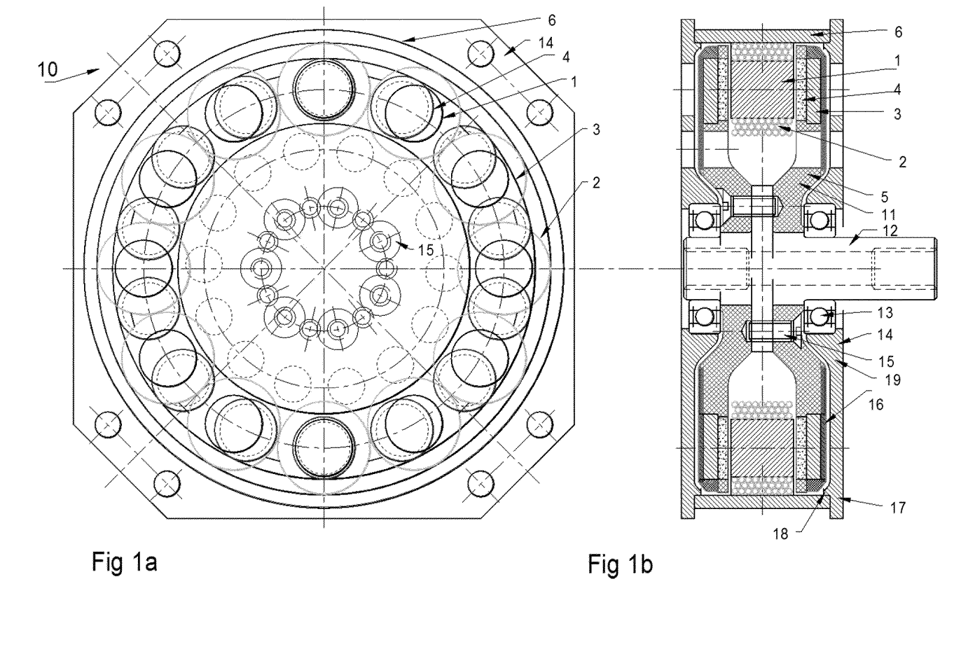

FIGS. 1a and 1b show an axial view and a cross-sectional view, respectively, of a first embodiment of the electrical machine. In this embodiment, the electrical machine is a transverse flux (or axial flux) electrical machine 10. The electrical machine 10 has a first part in the form of a rotor 11 and a second part in the form of a stator 17. In this embodiment, the stator 17 has twelve SMC cores 1 fixed to it. Each core 1 is surrounded by current-carrying windings in the form of a coil 2. The cores 1 have no pole shoes.

The rotor 11 is encased within the stator 17. This can be seen most clearly in FIG. 1b. The arrangement of the rotor 11 and the stator 17 to form the electrical machine 10 will be described in more detail below.

With reference to FIG. 1b, the stator 17 consists of two housing side plates 14 and a coil support 6. The coil support 6 holds the coils 2 and their respective cores 1 in place. The housing side plates 14 protect the rotor 11 and hold the coil support 6 in place relative to a shaft 12 of the rotor 11.

The coil support 6 is in the shape of a section of a tube. That is, it is in the shape of a ring whose inner and outer surfaces are generally flat in their axial directions. The coil support 6 is made from aluminium. The coils 2, containing the cores 1, are fixed to the radially inner surface of the coil support 6. The coils 2 and cores 1, and their attachment to the coil support 6, will be described in more detail below.

As mentioned above, the housing side plates 14 protect the rotor 11 and provide a mount for the coil support 6. The housing side plates 14 are mirror images of one another, in all but one respect. Namely, one of the side plates 14 defines a hole through which, when the electrical machine 10 is assembled, the shaft 12 of the rotor 11 extends, while the other side plate 14 does not. The housing side plates 14 are plates formed of aluminium. The housing side plates 14 are in the shape of a square with its four corners cut off. There is a central, circular, hole cut in one of the housing side plates 14 to allow a shaft 12 of the rotor 11 (described in more detail below) to pass through the housing side plate 14. One side of each housing side plate 14 is flat. This is the outer side when the electrical machine 10 is assembled. The other side of each housing side plate 14 (the inner side when the electrical machine 10 is assembled) defines protrusions 19, 18. There is an inner protrusion 19 in the shape of a ring, which is adjacent to the central hole in the housing side plate 14.

The inner protrusion 19 of each bearing side plate 14 accommodates a bearing 13 which, when the electrical machine 10 is assembled, is adjacent to the shaft 12. When the electrical machine 10 is assembled, the bearings 13 hold the side plates 14 against the shaft 12 of the rotor 11, while allowing the side plates 14 to remain stationary with respect to the shaft 12 while the shaft 12 is rotating.

The outer protrusion 18 is also in the shape of a ring. The outer protrusion is radially outward of the inner protrusion 19. The outer protrusion helps to support the coil support 6. Specifically, the coil support 6 is positioned axially inwardly of the two housing side plates 14 and radially outwardly of their outer protrusions 18. It is thus held axially in place by the housing side plates 14 and radially in place by the inner protrusions 19.

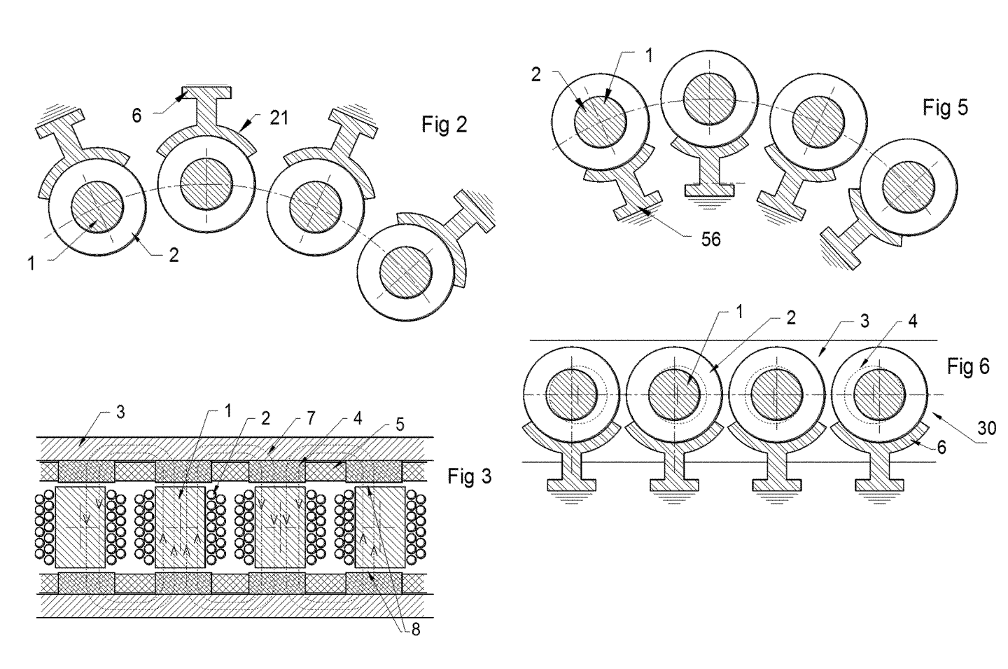

The arrangement of the coils 2 on the coil support 6 of the stator will now be described in more detail, with reference to FIG. 2. FIG. 2 shows schematically part of the coil support 6. Mounted on the radially inner surface of the coil support 6 are clips 21. There are twelve clips 21 (although only four are shown in FIG. 2), one for each stator core 1 and coil 2. Each clip 21 has arms 23 which are connected to the coil support 6 and which curve around the coil 2 to hold the coil 2 in place. In this way, each of the twelve coils 2 is supported by a clip 21 connected to the coil support 6, which is in turn connected to the housing side plates 14. The coils 2 have their axis parallel to the axis of the stator 17. That is, the axis of each coil 2 is perpendicular to the housing side plate 14 and parallel to the coil support 6.

In other embodiments, adhesive (e.g. resin) is used in place of the clips 21 to hold the coils 2 to the coil support 6. For example, in one alternative embodiment, the radially inner surface of the coil support 6 defines twelve indentations which are semi-circular in cross-section. A coil 2 is glued into each of these indentations in the coil support 6.

Each coil 2 is formed from electrically conducting wire. In this embodiment the wire is copper and is round in cross section. In other embodiments, other materials can be used for the wire provided they are electrically conducting. In other embodiments, the wire is square or rectangular in cross section. The coils 2 themselves are circular in cross section. The coils are wound by machine.

Once assembled, operation of the electrical machine 10 as a motor depends on the generation of a sufficiently high magnetic field by the passing of current through the coils 2. Conversely, operation of the electrical machine 10 as a generator depends on the generation by permanent magnets 4 (described below) of a sufficiently high current in the coils 2. To permit the maximum flux density through the coils 2, a core 1 of high permeability is provided in the centre of each coil 2. Once a coil 2 has been wound, a core 1 is inserted into the middle of the coil 2. The coils 2 define a central space which is circular in cross section and has approximately the same diameter as a core 1, such that the core 1 can easily be slotted into the coil 2.

In conventional electrical machines, cores within coils would have pole shoes to spread the flux in the air gap between magnets and the coils and so to reduce the flux density in the air gap. However, the cores 1 of the present electrical machine 10 are formed of SMC and so, as discussed above, pole shoes are unnecessary. Each core 1 is formed of soft magnetic compound. SMC is made up of iron particles which are covered in an electrically insulating coating, such that each particle is electrically insulated from the other particles. The particles are then formed into a shape and heat treated or cured such that the particles hold their shape. Each core 1 is manufactured in this way. Each core 1 is cylindrical in shape. That is, in side section it is rectangular, and in cross section it is circular. Each core 1 is therefore simple in shape.

With reference once more to FIG. 1b, the rotor 11 will now be described in more detail. The rotor 11 is generally yo-yo-shaped in cross-section. That is, in overall shape, the rotor 11 has two generally disc-shaped parts arranged parallel to one another and axially connected at their centres. The rotor 11 is made up of twin backing elements for its magnets 4, twin support rings 16 for these backing elements, and two discs of matrix material 5 which hold the magnets in place on the backing elements.

In this embodiment, the backing elements are in the form of yoke rings 3 formed of SMC. Each of the two yoke rings 3 is in the shape of a disc defining a circular hole (not visible in cross-section) at its centre. In other words, each of the two yoke rings 3 is annular in shape. Each yoke ring 3 is radially wide enough to accommodate the magnets 4. That is, the yoke ring 3 is wider than each of the magnets 4.

There are fourteen magnets 4 mounted on each yoke ring 3. The magnets are mounted on the face of each yoke ring 3 which is adjacent to the cores 1 and coils 2 when the electrical machine 10 is assembled. The magnets 4 are equally radially spaced around each yoke ring 3.

Each yoke ring 3 is in turn mounted on a support ring 16. The two support rings 16 are formed of composite material. Each support ring 16 acts to stiffen the yoke ring 3 which is mounted to it, to prevent it from flexing under magnetic forces. This is advantageous since in being formed of SMC, the yoke rings 3 are somewhat brittle. The support rings 16 therefore help to prevent damage to the yoke rings 3. Each support ring 16, like the yoke rings 3, is annular in shape. The radial distance from the central hole in each support ring 16 to the outer edge of each support ring is greater than the radial distance from the central hole in each yoke ring 3 to the radially outer edge of each yoke ring 3. The outer edge of the yoke ring 3 axially abuts the outer edge of its respective support ring 16.

Each yoke ring 3—support ring 16 pair is held in place on the rotor shaft 12 by a disc of matrix material 5. One disc of matrix material 5 is glued to the axially-inner face of one of the yoke rings 3 and also to the part of the axially-inner face of the support ring 16 on which the yoke ring 3 is mounted that is exposed. The other disc of matrix material 5 is likewise glued to the other yoke ring 3 and support ring 16. The magnets 4 are exposed through respective circular holes in the discs of matrix material 5.

The two discs of matrix material 5 each have a central hole. These central holes are of equal dimensions. They are smaller in diameter than the central holes in the yoke rings 3 and support rings 16. A shaft 12 extends axially through the holes in each of these components. The shaft 12 has a radial protrusion to which the discs of matrix material 5 are fixed by countersunk screws 15. One disc of matrix material 5 is fixed on one side of the radial protrusion on the shaft 12. The other disc of matrix material 5 is fixed on the axially opposite side of the radial protrusion on the shaft 12. Thus, although the yoke rings 3 do not touch the shaft 12, they are held in place on the shaft 12 by the discs of matrix material. This holds the magnets 4 at a radial distance from the shaft 12 such that they radially align with the cores 1 and coils 2 of the stator 17.

The two discs of matrix material 5 each have an axial depression towards their centre. The axial depressions slope radially inwards from the part of each disc of matrix material 15 that is fixed to the support ring 16. Thus, when the discs of matrix material 5 are fixed to the radial protrusion on the shaft 12, a central part of each disc of matrix material 5 is axially closer to the other disc of matrix material 15 than a radially outer part of each disc of matrix material 5. In other words, the radially outer parts of the discs of matrix material 5 are further apart from one another than the radially-inner parts of each disc of matrix material 5. The greater axial distance between the radially outer edges of the discs of matrix material 15 allows the cores 1 and coils 2 mounted on the coil support 6 of the stator 17 to be accommodated between the two yoke rings 3 of the rotor 11.

Thus, when the electrical machine 10 is assembled, the magnets 4 mounted on each yoke ring 3 face each other, with the cores 1 and coils 2 axially between them. In having two yoke rings 3, each supporting an equal number of magnets 4, the axial magnetic forces can be balanced. To keep the axial magnetic forces balanced, the two discs of matrix material 5 are mirror images of each other to ensure that the air gap between the magnets 4 and coils 2 is even.

[Operation of Outer Stator Rotating Electrical Machine]

FIG. 3 shows a schematic radial view of the arrangement of magnets 4, coils 2 and cores 1 in the electrical machine described above with reference to FIGS. 1 and 2.

The electrical machine 10 can be operated either as a motor or as a generator. In operation as a motor, the coils 2 are connected to a supply of alternating current (not shown). FIG. 3 shows the flux lines 7 of the magnetic field generated by passing current through the coils 2. The alternating direction of the current through the coils 2 urges the pairs of magnets 4 towards successive coils 2. Since, as described above, the magnets are connected by the matrix material 5 to the shaft 12, the rotation of the magnets 4 causes a torque to be applied to the shaft 12. Conversely, when the electrical machine 10 is operated as a generator, rotation of the shaft causes the magnets 4 to rotate about the coils 2, inducing an alternating current in the coils 2.

[Inner Stator Electrical Machine]

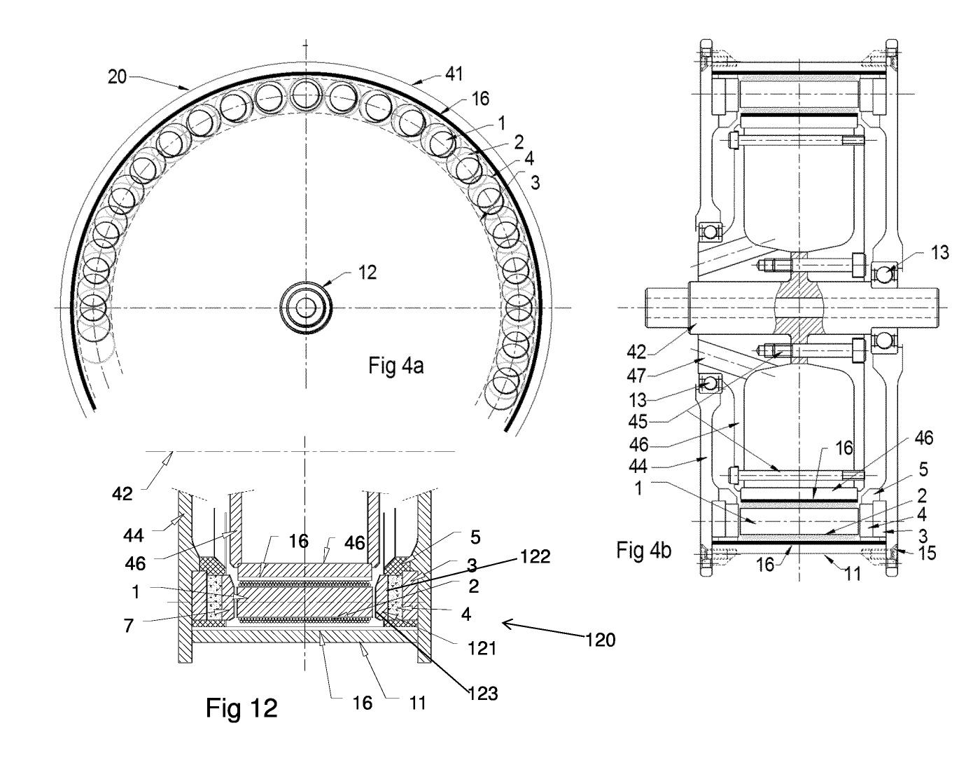

FIGS. 4a and 4b show an axial view and a cross-sectional view, respectively, of a second embodiment of the electrical machine. In this second embodiment, the machine is an inner stator rotating electrical machine 20. The rotor forms part of the hub of an electric bicycle (not shown). Like the electrical machine 10 of the first embodiment, the electrical machine 20 of the second embodiment has a first part in the form of a rotor 11 and a stationary part in the form of a stator 17. Like the electrical machine 10 of the first embodiment, this inner stator electrical machine 20 is a transverse flux (or axial flux) electrical machine. Unlike the electrical machine 10 of the first embodiment, in this second embodiment, the stator 17 is encased within the rotor 11. In this embodiment, the electrical machine 20 has 76 permanent magnets. It has 38 magnets mounted on each of two yokes 3 of the rotor 11. The electrical machine 20 has 36 coils 2 mounted on its stator 17. Each of the 36 coils 2 has a respective core 1 formed of SMC within it.

With reference to FIG. 4b, the stator 17 consists of two circular plates, each having a hole at its centre. The central spindle 42 extends axially through the central hole in each of the plates of the stator 17. In much the same way as the discs of matrix material 5 of the first embodiment 10 are fixed to a radial protrusion on the shaft 12 of the first embodiment, the stator 17 plates of the second embodiment 20 are each fixed to a radial protrusion on a central spindle 42 by tie bolts 45. The radially outer edges of the two plates of the stator 17 are secured to one another by further tie bolts 45.

Fixed in a ring around the radially outer edges of the plates of the stator 17 is a coil support 46. The coil support 46 is annular in shape. That is, the coil support 46 is shaped like a section of a hollow tube. On the radially-outer surface of the coil support 46, there is a ring of composite reinforcement 16. To this ring of composite reinforcement 16 are mounted 36 coils 2. These coils 2 are generally the same as the coils of the first embodiment. Within each coil 2 is a core 1 of SMC. Again, these cores 1 are as described above in relation to the first embodiment. The mounting of the coils 2 to the composite reinforcement 16 is achieved in this second embodiment in the same way as the mounting of the coils 2 to the coil support 6 of the first embodiment. That is, each coil is clipped to the layer of composite reinforcement 16 around the coil support 46. FIG. 5 shows schematically an axial view of the arrangement of 4 of the cores about the coil support 46. In overview then, the stator 17 of this embodiment provides a mount for coils arranged radially outwardly of the stator 17.

One of the two plates of the stator 17 has bores through it adjacent the connection to the central spindle 42. These bores provide cable access 47 so that the coils 2 mounted on the stator 17 can be connected to an electric circuit (not shown).

With continued reference to FIG. 4b, also mounted on the central spindle 42 is a rotor 11. The rotor 11 consists of two hub side plates 44, one on one axial side of the coils 2 supported by the stator 17, and the other hub side plate 44 on the other axial side of the coils 2. The hub side plates 44 are connected to one another around their radially outer edges by an annulus of composite reinforcement 16. This composite reinforcement 16 holds the hub side plates 44 at an axial distance from one another sufficient to accommodate the coils 2 between them. A yoke ring 3 formed of SMC is mounted on the inner face of each of the hub side plates 44. The yoke ring 3 is of the same shape as the yoke ring 3 described above in relation to the first embodiment.

To each of the two yoke rings 3, there are mounted 38 magnets. The arrangement of the magnets 4 and yoke ring 3 is a described above with reference to FIGS. 1 and 2. In this embodiment, however, there are more magnets 4 than in the first embodiment. The magnets 4 are mounted on the yokes 3 such that they face one another in pairs across the stator 17.

One of the hub side plates 44 is mounted directly to the central spindle 42 by a bearing 13. The other hub side plate 44—the one that is axially adjacent the plate of the stator 17 that has the bores for cable access 47—is mounted to a radially-inner, axially-outer part of the stator 17. Again, it is mounted on bearings 13 to enable it to rotate with the other plate of the rotor 11 about the central axis.

Operation of this electrical machine 20 is as described above in relation to the first embodiment 10 of the electrical machine, except that since the rotor 11 in this second embodiment is external to the stator 17, it is the outer part of this electrical machine 20 which rotates.

[Linear Actuator]

The principles described above in relation to the first two embodiments can also be applied to a linear actuator 30. A schematic side view of such a linear actuator is shown in FIG. 6. In operation, the magnets 4, visible in this figure outlined in dots, are mounted on a first, moving part, while the coils 2 are mounted on a second, stationary part. In other embodiments, the coils 2 can be mounted on a first, moving part, while the magnets 4 are mounted on a second, stationary part.

[Powered Wheel]

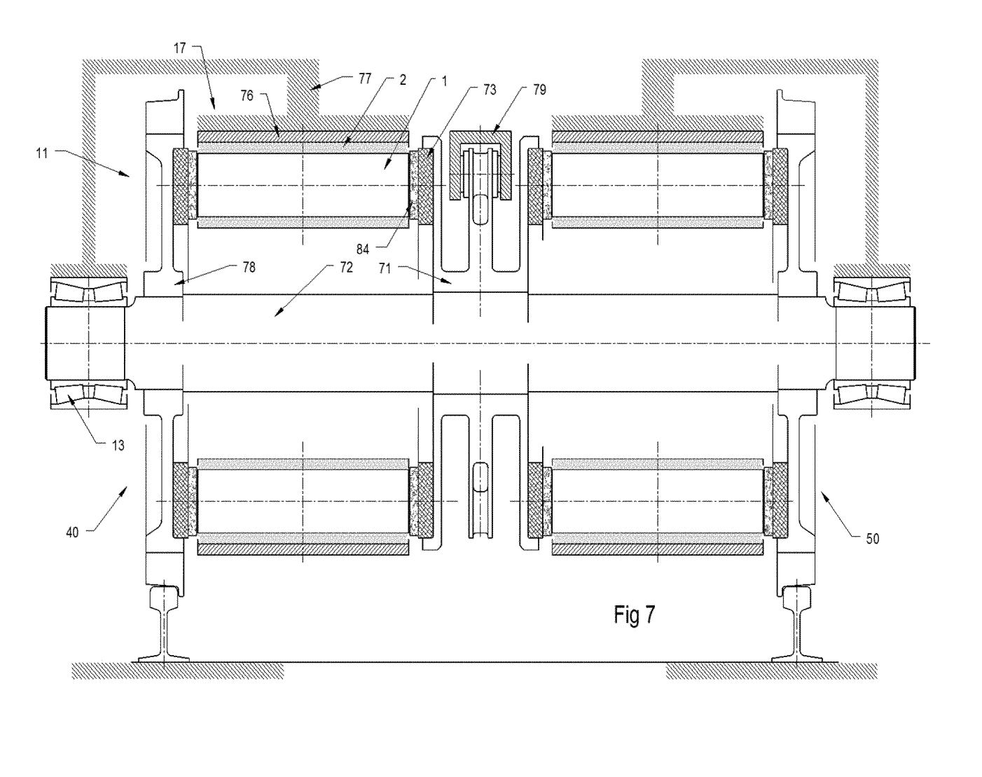

FIG. 7 shows, in cross-section, two wheels 78 and an axle 72 of a train (not shown), with an electrical machine 40, 50 mounted to each wheel 78. When the electrical machines 40, 50 are operated as motors, this arrangement propels the train by turning the axle 72 and the wheels 78 mounted to the axle 72. Other axles of the train are also provided with similar arrangements.

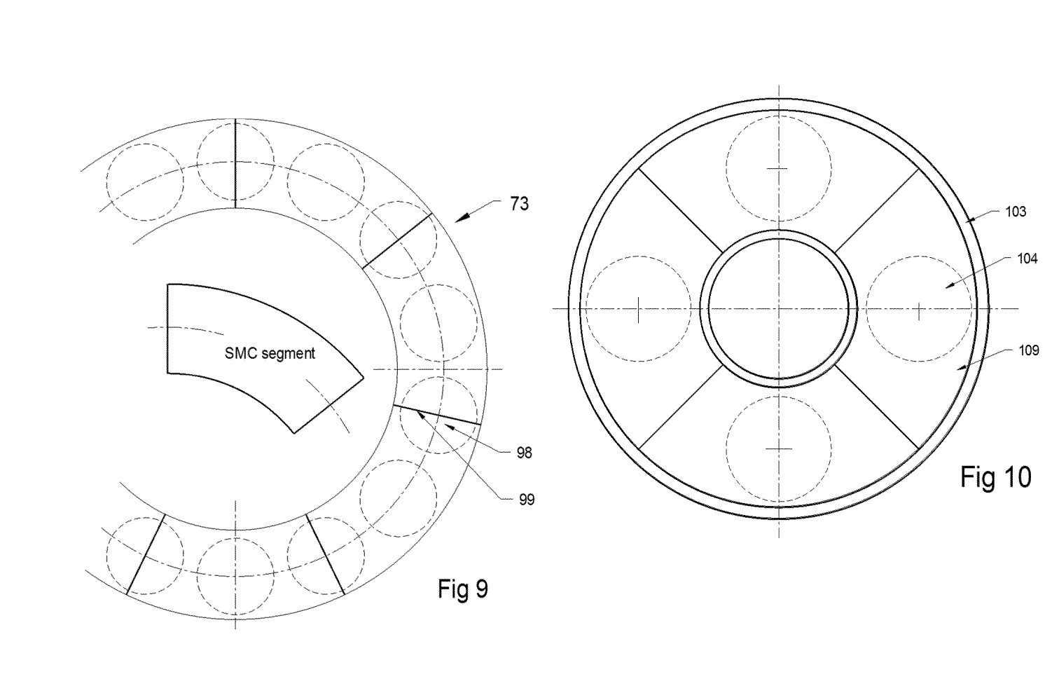

The two electrical machines 40, 50 are mirror-images of each other. Only the electrical machine 40 shown on the left of FIG. 7 will therefore be described in detail here. The stator 17 of the electrical machine 40 is mounted to the axle 72 of the wheel 78 via bearings 13 and a support structure 77. Permanent magnets 84 mounted to the wheel 78 form a rotor 11. Cores 1 and coils 2 are arranged on the stator 17 as described above with reference to FIGS. 1b and 2. The permanent magnets 84 are arranged relative to the cores 1 and coils 2 as also described above with reference to those figures. Instead of being mounted on SMC yoke rings 3 to discs 5 of matrix material, one set of magnets 84 is mounted on an SMC lining ring 73 to the axially inner face of the wheel 78, and the other set of magnets 84 is mounted on another SMC lining ring 73 to a brake disc 71, axially half-way between the two wheels 78. The SMC lining rings 73 will be described in more detail below, with reference to FIG. 9. In overall shape, however, each SMC lining ring 73 is generally line each SMC yoke ring 3, although larger, in order to support the magnets 84 on the wheels 78 and brake disc 71.

The wheels 78 and brake disc 71 are made of steel. Steel is a good backing material for the magnets 84. However, because of the large homogeneous mass of the wheels 78 and brake disc 71, without the SMC lining rings 73, they would generate large iron losses, especially at high operating speeds. Lining the wheels 78 and brake disc 71 with SMC lining rings 73 reduces iron losses. This makes it practical to mount the electrical machine to the axle 72 and wheels 78 without gear transmission between them. In turn, this reduces the cost and weight of arrangements for driving the axle 71 of a train.

[SMC Lining Ring]

FIG. 9 shows a substrate of SMC in the form of an SMC lining ring 73 that can be used with the arrangement described above with reference to FIG. 7. The SMC lining ring 73 is in the shape of a disc defining a circular hole at its centre. In other words, it is annular in shape. The radial distance between the edge of the hole and the radially-outer edge of the SMC lining ring 73 is great enough to accommodate magnets 84. That is, the SMC lining ring 73 is wider than each of the magnets 84. In shape, it is therefore similar to the SMC yoke ring 3 described above with reference to FIG. 1b. For applications such as that described above with reference to FIG. 7, that is, applications in which the SMC lining ring 73 is required to be of large dimensions, the SMC lining ring 73 is made up of substrate segments. There are seven segments in this embodiment. In embodiments where a larger lining ring 73 is required, more segments are used in order to keep each segment of a size which can easily be formed of SMC. The segments are the shape of sectors of an annulus. In other words, the lining ring 73 is divided along radial lines. In this embodiment there are seven radial dividing lines 99.

SMC is brittle and so forming and curing large parts in SMC is difficult. Assembling the SMC lining ring 73 from segments of SMC means that smaller parts are required to be made than if it were formed in one piece and manufacture of the SMC lining ring 73 is therefore made easier.

The dashed circles in FIG. 9 indicate the position 98 of magnets 84 on the SMC lining ring 73 when it is used in an electrical machine. The magnets 84 are evenly spaced around the SMC lining ring 73. In this embodiment, fourteen magnets 84 are positioned radially around the SMC lining ring 73. One magnet 84 is positioned over each radial dividing line 99. The remaining seven magnets 84 are positioned with one magnet 84 between each magnet 84 that is positioned over a radial dividing line 99.

[Engine Flywheel]

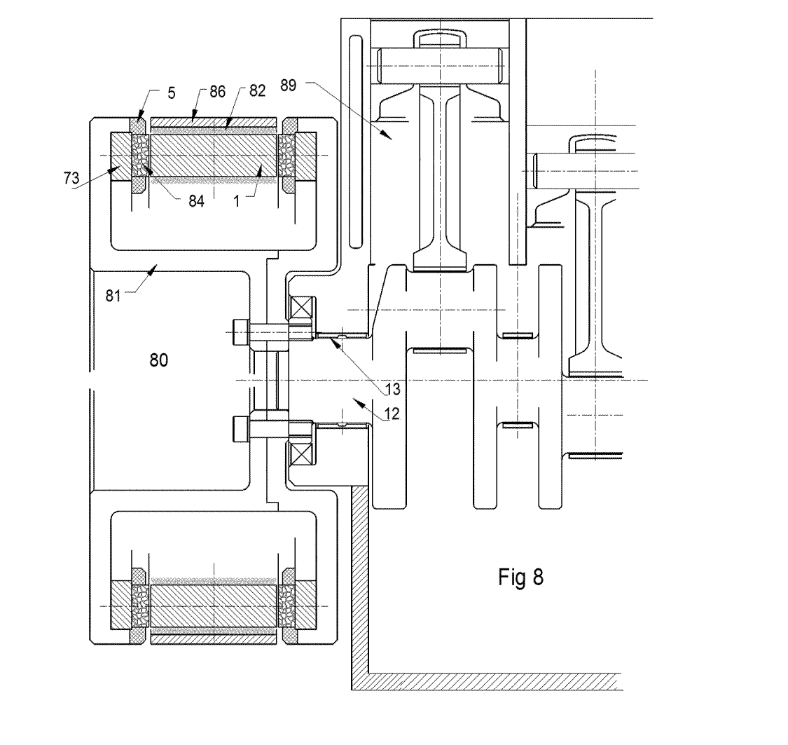

FIG. 8 shows in cross section an electrical machine 80 with a first part in the form of a modified flywheel 81 of an internal combustion engine (ICE) 89. The electrical machine 80 is arranged to function as a starter-generator. Like a standard flywheel, the modified flywheel 81 of this embodiment is mounted to the crankshaft 82 of the IC. Unlike a standard flywheel, however, the modified flywheel 81 of this embodiment resembles the rotor 11 of the embodiment described above in relation to FIG. 1b. Specifically, the modified flywheel 81 is formed of two discs, co-axially connected, with magnets 84 mounted on their axially-inner faces. The magnets 84 are fixed to an SMC lining ring 73, as described above with reference to FIGS. 7 and 9. Coils 2 are mounted on the inner surface of an outer casing 86 as described above in relation to the coils 2 and coil support 6 of the first embodiment.

In operation, the electrical machine 80 can function as a starter motor. To start the ICE 89, current is passed through the coils 2. This causes the flywheel 81 to turn, in the same manner as passing a current through the coils 2 of the outer stator electrical machine 10 described with reference to FIG. 1b causes its rotor 11 to turn. Turning the flywheel 86 causes the crankshaft 82 to turn, starting the ICE.

The electrical machine 80 can also operate as a generator. Spinning of the flywheel 86 by pistons of the ICE 89 induces a current in the coils 2 which can be used, for example, to charge a vehicle battery.

Incorporating the electrical machine 80 with the engine flywheel 81 provides a more compact arrangement for a starter-generator. It also eliminates the need for a gear transmission to allow the crankshaft 82 to be turned by an electrical machine operating as a motor, or to have the rotor of the electrical machine turned by the crankshaft when the electrical machine is operated as a generator. Such an electrical machine 80 can be used to convert electric vehicles to series hybrid operation.

[Segment Magnets]

FIG. 10 shows an alternative arrangement of magnets to be used in an electrical machine for applications where cogging is to be minimised. In this arrangement, there are four magnets 109 mounted on an SMC yoke ring 103. The SMC yoke ring 103 is generally the same as the SMC yoke ring 3 described above with reference to FIG. 1b. By contrast to the magnets 4 of the first embodiment, however, the magnets 109 of this embodiment are not round but are shaped like sectors of an annulus so that when assembled and mounted on the SMC yoke ring 103, the magnets 109 make up a ring.

This arrangement has particular advantages when a low number of magnetic poles are required in an electrical machine. When a low number of magnetic poles are required, round magnets give good running efficiency due to the low volume of magnetic material, but can lead to bad cogging when the machine is operated. In electrical machines to be used where full torque is required from starting the machine, such as in a bicycle drive (where cogging will be felt as “lumpiness” when accelerating), it is desirable to minimise cogging. Magnets 109 of the shape described above reduce cogging, because spaces between the magnets are minimised.

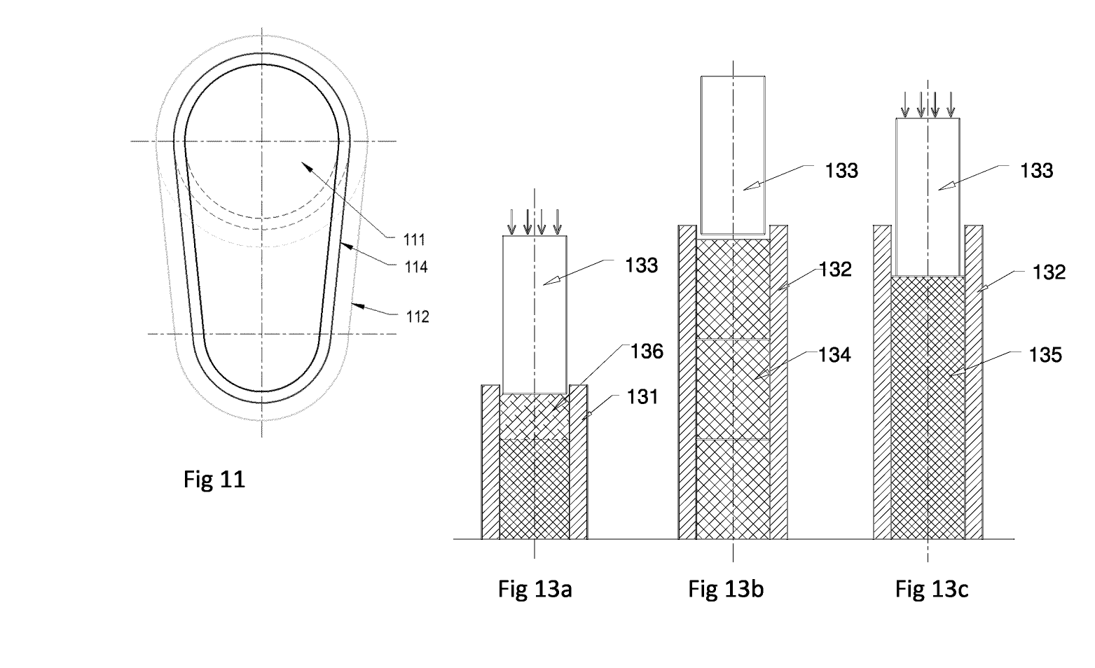

FIG. 11 shows yet another shape of magnets to be used in an electrical machine for applications where cogging is to be minimised. The magnet 114 shown is shaped such that when many similarly-shaped magnets are arranged side-by-side, they form a ring. Specifically, the magnet 114 has a cross-sectional shape having an outline described by a two circles joined by two non-intersecting tangents to the circles. In other words, the magnet 114, in cross-section, is shaped like a trapezoid, with a semicircle having a diameter equal to the length of one of the parallel edges of the trapezoid joined to that edge of the trapezoid along the straight edge of the semicircle, and a second semicircle having a diameter equal to the length of the other parallel edge of the trapezoid joined to that edge of the trapezoid along the straight edge of the semicircle. The diverging edges of the trapezoid form straight edges of the magnet. Placing magnets 114 adjacent one another with their straight edges abutting forms a ring of magnets. As with the magnets 109 described above in relation to FIG. 10, therefore, when assembled and mounted on the SMC yoke ring, these magnets 114 make up a ring.

FIG. 11 also shows a shape of cores 111 to be used with the magnets described above in relation to this figure. The cores 111 have the same cross-sectional shape as the magnets 114, but have a smaller cross-sectional area. This helps to minimise stray flux in the electrical machine and enhance its performance.

[Flux Concentrators]

FIG. 12 shows part of a ninth embodiment 120 of the electrical machine in which SMC elements in the form of flux concentrators 121 made from SMC are used to attenuate the flux levels of the magnets 4. In this embodiment, the magnets 4 are Ferrite-based. These are generally cheaper than Neodymium-based magnets, but can be demagnetised at lower flux densities through the magnets 4. The flux concentrators 121, by spreading magnetic flux through the magnets 4, allow the SMC cores 1 to be used at similar effective flux levels to more expensive magnets, such as Neodymium-based magnets.

Each flux concentrator 121 is shaped like a conical frustum (that is, a truncated cone) mounted at its base to a section of a cylinder. In cross-section, therefore, each flux concentrator 121 is wider at one end and tapers towards its other end. At the wider end, each flux concentrator 121 has a first face 122. Each flux concentrator 121 narrows towards a second face 123 of smaller cross-sectional area than the first face 122.

The first face 122 of each flux concentrator 121 is glued to the face of a magnet 4 that is axially closest to the cores 1. The first face 122 of each flux concentrator 121 is the same shape as that face of the magnet and has the same surface area. Thus all magnetic flux that passes through the magnet 4 passes through the flux concentrator 121. The second face 123 of the flux concentrator 121 is the same shape as a cross-section of any of the cores 1. The surface area of the second face 123 is the same as the cross-sectional area of any one of the cores 1. Thus, when a core 1 is radially aligned with one of the flux concentrators 121, magnetic flux is channelled by the flux concentrator 121 through the core 1 and magnet 4 on which the flux concentrator 121 is mounted. The matrix material 5 helps to keep the flux concentrators 121 in place on the magnets 4.

The flux concentrators 121 work in a similar way to pole shoes; in use, they spread the flux axially adjacent the magnets 4 and concentrate it through the cores 1. The flux concentrators 121 thus provide similar advantages without the need for pole shoes. The flux concentrators 121 are easier to manufacture and less fragile than SMC cores with pole shoes, since they are of simpler shape.

[Method of Manufacturing Cores]

FIGS. 13a, 13b and 13c show steps in a process of making a core 135 for an electrical machine. In a first step, shown in FIG. 13a, SMC powder 136 is placed in a tubular die 131 and a punch 133 having a circular cross-section with a diameter slightly less than the inner diameter of the die 131 is inserted into the die 131. Force is applied to the punch 133. This compresses the powder 136 so that it is of roughly uniform density throughout. In this way, a first cylindrical part is formed of SMC. In a second step, a second cylindrical part is formed in the die 131 in the same way. In this embodiment, a third cylindrical part is also formed in the same way. Next, all three parts are inserted into a second die 132. The second die 132 is shaped like the first die 131, but is long enough to accommodate the three parts end to end. A punch 133 having a circular cross-section with a diameter slightly less than the inner diameter of the die 132 is inserted into the die 132. Force is applied to the punch 133 so that the three parts are compressed together within the die. Because the three parts are within the die, there is no burr where they join. The method can thus be used to produce a core having a length of at least 1.5 times its diameter, with a uniform density and no burrs.

[Multiple Arrays of Poles and Magnets]

In another alternative embodiment, the electrical machine is as described above with reference to FIG. 1, but has two arrays of magnets and two arrays of cores and coils. As with the embodiment described with reference to FIG. 1, an array of magnets is arranged in a ring around the axis of rotation of the rotor, and an array of cores is also arranged in a ring around the axis. In this alternative embodiment, however, there is a second array of magnets also arranged in a ring around the axis of rotation of the rotor, and a second array of cores also arranged in a ring around the axis. The second array of magnets is radially inside the first array of magnets. Similarly, the second array of cores is radially inside the first array of cores. The radial distance from the axis to the second array of magnets is equal to the radial distance from the axis to the second array of cores.

In operation the second arrays of cores and magnets interact in the manner described above in relation to the cores and magnets of the electrical machine described with reference to FIG. 1. The second arrays increase the number of active parts within the electrical machine. Since the second arrays are positioned radially inside the first arrays, the size of the electrical machine in this embodiment is not much greater than the size of the electrical machine described with reference to FIG. 1. In this embodiment, there are therefore more active parts within an electrical machine that is not much bigger than the electrical machine described above. Thus the performance of the electrical machine is enhanced without greatly increasing its size.

[Schematic View of Potential Electrical Machines]

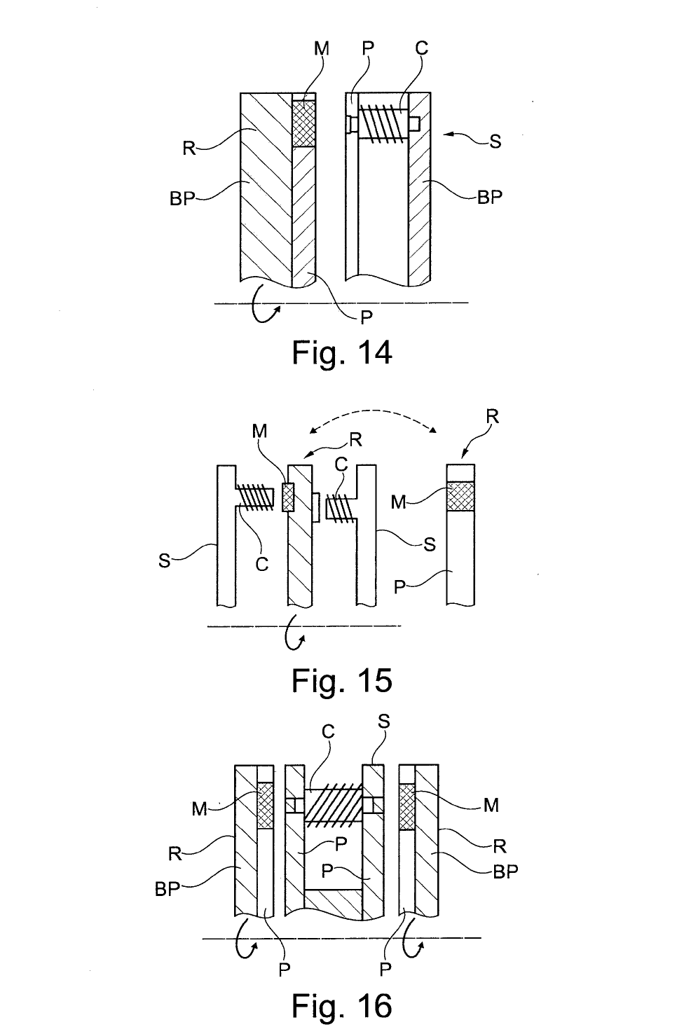

FIGS. 14, 15 and 16 each show a specific stator-rotor arrangement of the electrical machine. Each stator S might be a single piece like in FIG. 15 or a multipart piece like shown in FIG. 14 and FIG. 16. There, each core C made from powder SMC might have a step at least at one of its ends by which fixation is possible, preferably with a press fit. The stator is preferably made from powder SMC, at least the stator's back plate BP. The core might be mounted in the back plate using different technologies, even use of glue is possible. The rotor R and its back plate BP is made also preferably from powder SMC. The Rotor might also comprise an appropriate, nonmagnetric material P, like Pertinax.

The magnets M are either mounted by press fit, see e.g. FIG. 15, or might be fixed with an appropriate nonmagnetic material P, like Pertinax on the back plate whereby the back plate preferably is made from powder SMC, as shown e.g. in FIG. 14. An alternative rotor R is shown in FIG. 15 adjacent to the stator-rotor-stator arrangement.

1. A rotating or linear electrical axial flux machine comprising a first part and a second part, the first part moveable relative to the second part, one of the first part and the second part having a plurality of cores for current-carrying windings, wherein each core is of powder soft magnetic composite material (SMC) and is shaped to be no wider at its ends than along its length.

2. The electrical machine of claim 1, wherein each core is substantially circular in cross-section or each core is substantially a shape of a sector of an annulus in cross-section, whereby one of the first part and the second part has a plurality of magnets.

3. The electrical machine of claim 2, wherein each magnet is substantially round in cross section or wherein each magnet is substantially a sector of an annulus in cross-section.

4. The electrical machine of claim 2, further comprising an element of SMC coupled to each magnet, each element shaped to increase the density of magnetic flux through a core.

5. The electrical machine of claim 2, wherein the plurality of magnets comprises a first set of magnets and a second set of magnets and the plurality of cores is arranged axially between the first set of magnets and the second set of magnets.

6. The electrical machine of claim 2, wherein the part having the plurality of magnets comprise a substrate formed of SMC on which the magnets are mounted.

7. The electrical machine of claim 6, wherein the substrate is made up of a plurality of substrate segments and wherein each substrate segment is arranged to substantially abut radially two other substrate segments.

8. The electrical machine of claim 7, wherein a magnet is mounted at each point where two substrate segments substantially abut.

9. The electrical machine of claim 2, wherein the plurality of cores for current-carrying windings is a first plurality of cores, and there is a second plurality of cores, and wherein the plurality of magnets is a first plurality of magnets and there is a second plurality of magnets, and wherein the first plurality of cores is arranged at a radial distance from the axis substantially equal to the distance from the axis at which the first plurality of magnets is arranged, and the second plurality of cores is arranged at a radial distance from the axis substantially equal to the distance from the axis at which the second plurality of magnets is arranged.

10. The electrical machine of claim 1, wherein a back plate of a stator comprising compressed soft magnetic composite powder material (SMC) is in contact with each core made from compressed soft magnetic composite powder material (SMC).

11. The electrical machine of claim 1, wherein a rotor adjacent to a stator of the electrical machine comprises a plurality of magnets wherein at least a part of the rotor in contact with the magnets is made from compressed soft magnetic composite powder material (SMC).

12. The electrical machine of claim 1, comprising at least a single stator adjacent to one single rotor, one single rotor between two stators or one single stator between two rotors.

13. The electrical machine of claim 1, wherein the electrical machine is part of an axle apparatus for a vehicle.

14. The electrical machine of claim 1, wherein the electrical machine is a part of a flywheel apparatus for an internal combustion engine, whereby the first part is arranged to be mounted a flywheel for connection to a crankshaft of an internal combustion engine.

15. The electrical machine of claim 1, wherein the electrical machine is at least one of a linear electrical machine, a part of a medical device, a part of a blood or heart pump, a compressor, an air conditioning compressor, a fluid pump, a part of a wind turbine, a part of a vertical axis wind turbine, a part of a Darrieus wind turbine, an automotive part, a bicycle part, a motorbike part, a train part, a gear par and a driveline part.

16. A method for manufacturing a core of an electrical axial flux machine wherein each core of the electrical axial flux machine is made of soft magnetic composite material (SMC) and is shaped to be no wider at its ends than along its length, wherein the method comprises
(a) compressing SMC powder to form a first part of substantially uniform density,
(b) compressing SMC powder to form a second part of substantially uniform density, and
(c) compressing the first part and the second part together to form a core of substantially uniform density.

17. A method for manufacturing a core of an electrical axial flux machine wherein each core of the electrical axial flux machine is made of soft magnetic composite material (SMC) and is shaped to be no wider at its ends than along its length, wherein the method comprises gradually building up a part, by placing SMC powder in a die, compressing the powder using a punch, withdrawing the punch, adding more SMC powder, and compressing this, to finally build the core.

18. A method according to claim 16, wherein all cores of the electrical axial flux machine together are integrated in a base plate made of soft magnetic composite material (SMC) which serves for a magnetic reflux whereby the base plate is made by compressed SMC powder.

19. A method according to claim 16, wherein the parts of the cores are compressed together to achieve a core length of at least 1.5 times of its width.
